(19) United States
(12) Patent Application Publication
(10) Pub. No.: US 2016/0009373 A1
(43) Pub. Date: Jan. 14, 2016

(54) Variable Blade Pitch Propeller Assembly

(71) Applicant: Aerovate Inc., Thunder Bay (CA)

(72) Inventors: Andrew Kondor, Thunder Bay (CA); Christopher Michael Rudnicki, Thunder Bay (CA); Michael Anthony Rudnicki, Thunder Bay (CA); Tyler J. F. Bragnalo, Kaministiquia (CA)

(21) Appl. No.: 14/674,888

(22) Filed: Mar. 31, 2015

Related U.S. Application Data
(60) Provisional application No. 61/972,797, filed on Mar. 31, 2014.

(51) Int. Cl. B64C 11/06; B64C 27/46; B64C 27/39

(52) U.S. Cl. CPC B64C 11/06; B64C 27/39; B64C 27/46

(57) ABSTRACT

A propeller assembly has a main hub and a propeller hub circumferentially movable relative to the main hub about a main axis of the assembly. Circumferentially spaced propeller blades on the propeller hub are i) circumferentially movable together with the propeller hub relative to the main hub between a first position and a second position against a biasing force, and ii) pivotal about respective radial axes. A pitch linkage mechanism is operatively connected between each propeller blade and the main hub such that each propeller blade is pivotal about the respective radial axis from a first pitch orientation to a second pitch orientation together with movement of the propeller hub relative to the main hub from the first position to the second position responsive to air resistance in the second direction exceeding the biasing force.

This application claims the benefit under 35 U.S.C. 119(e) of U.S. provisional application Ser. No. 61/972,797, filed Mar. 31, 2014.

### FIELD OF THE INVENTION

The present invention relates to a propeller assembly comprising a plurality of propeller blades supported such that the blade pitch is variable, and more particularly the present invention relates to a propeller assembly in which the blade pitch is varied passively and automatically in response to an operating condition of the propeller assembly.

### BACKGROUND

Variable pitch propellers whose blade pitch can be adjusted are generally known to adapt the propeller to different thrust levels and air speeds so that the propeller blades don't stall, for optimizing efficiency of the propulsion system. Especially for cruising, the engine can operate in its most economical range when the propeller pitch is adjusted to a courser pitch as compared to a first pitch for take-off for example.

In many aircraft, the pitch is controlled automatically without the pilot's intervention. One common type of controllable pitch propeller is hydraulically actuated, while another common type includes an electrically operated mechanism. In both instances, numerous components are required such that the pitch controller requires regular maintenance to ensure proper operation.

For lighter aircraft, hydraulic pitch controllers are often considered too expensive and bulky, such that light aircraft tend to use propellers that are activated electrically, or mechanically, and in some instances manually. There exists a need for an improved pitch controller which is simple in design so as to remain lightweight and require minimal maintenance, while being operated in an automatic manner without the pilot's intervention.

### SUMMARY OF THE INVENTION

According to one aspect of the invention there is provided a propeller assembly for use with an aircraft having a motor output driven to rotate by a motor of the aircraft, the propeller assembly comprising:

a main hub member arranged to be coupled in fixed relation to the motor output of the aircraft for rotation therewith about a main axis in a forward direction of rotation;

a propeller hub member supported on the main hub member so as to be movable relative to the main hub member about the main axis in a second direction opposite to the forward direction of rotation between a first position and a second position which is circumferentially offset from the first position;

a biasing mechanism arranged to bias the propeller hub relative to the main hub member from the second position towards the first position;

a plurality of propeller blades supported on the propeller hub member at circumferentially spaced apart positions about the main axis so as to extend generally radially outward from the main axis;
the propeller blades being movable together with the propeller hub member relative to the main hub member between the first position and the second position; and
the propeller blades each being pivotal about a respective radial axis between a respective first pitch orientation and a respective second pitch orientation; and

a pitch linkage mechanism operatively connected between each propeller blade and the main hub member such that each propeller blade is pivotal from the respective first pitch orientation towards the respective second pitch orientation together with movement of the propeller hub member relative to the main hub member from the first position towards the second position responsive to air resistance in the second direction overcoming a biasing force of the biasing mechanism acting in the forward direction.

Preferably the first pitch orientation of the propeller blades corresponds to a finer blade pitch than the second pitch orientation of the propeller blades.

The pitch linkage assembly is a simple mechanical device which is actuated automatically as air resistance exceeds the initial biasing force of the biasing mechanism. Accordingly, minimal components are required such that the design is lightweight and very reliable in operation. Furthermore the passively actuated mechanism requires no pilot intervention while maintaining operation of the aircraft in an optimal range of efficiency by adjusting the blade pitch through a range of pitch angles proportionally with air resistance acting against the rotation of main hub relative to the aircraft.

Preferably the propeller assembly further comprises a cover member which is mounted in fixed relation to the main hub member. In this instance, preferably some or the entire propeller hub member is received between the cover member and the main hub member in an axial direction of the main axis.

In this instance, an annular bearing member is supported between the propeller hub member and each one of the main hub member and the cover member, at respective inner and outer sides of the propeller hub member.

The cover member can be fixed to the main hub member by a plurality of fasteners extending in a direction of the main axis in fixed connection between the cover member and the main hub member. Each fastener extends through openings in the propeller hub member which permit unrestricted movement of the propeller hub member relative to the fasteners.

Preferably a first annular sealing member is supported in a respective groove within one of the propeller hub member or the cover member for sealing engagement between the main hub member and the cover member while permitting relative movement therebetween about the main axis.

Preferably at least one stop member protrudes axially from a portion of one of the main hub member and the propeller hub member, and a corresponding slot is provided to extend circumferentially in another one of the main hub member and the propeller hub member which receives said at least one stop member therein such that said at least one stop member is displaced between terminally opposed ends of the slop as the propeller hub member is displaced between the first position and the second position relative to the main hub member.

The propeller assembly may further include a starter bore extending axially through the main hub member from an outer end open to the exterior of the propeller assembly and a cross member extending diametrically across the starter bore in fixed relation to the main hub member.

According to a preferred embodiment of the present invention, the biasing mechanism comprises at least one helical torsion spring operatively coupled between the main hub member and the propeller hub member.

Preferably said at least one helical torsion spring comprises a pair of helical torsion springs at axially opposing ends of the propeller hub member.

Preferably said at least one helical torsion spring is secured at one end to a collar member which is fixed to the propeller hub member by fasteners.

According to a preferred embodiment, the pitch linkage mechanism comprises a pin member fixed to an inner end of each propeller blade to extend radially in relation to the respective radial axis, and a socket at a circumferentially restricted location on the main hub member in association with each propeller blade which receives the respective pin member therein. Furthermore, a spherical bushing may freely pivotal in each socket such that each pin member is received in the respective spherical bushing for relative linear sliding movement therebetween. Preferably each socket is formed in an anchor body which is supported for pivotal movement relative to the main hub member about a respective axis which is parallel to the main axis.

According to an alternative embodiment, the biasing mechanism comprises a plurality of circumferentially spaced apart spring members, each being arranged to be compressed in a circumferential direction about the main axis of the main hub member between a first abutting surface on the main hub member and a second abutting surface on the propeller hub member.

According to the alternative embodiment, the pitch linkage mechanism includes a guide surface associated with each propeller blade which is in fixed relation to the main hub member and a follower associated with each propeller blade in mating connection with a respective one of the guide surfaces. Each guide surface may take the form of a groove within an inner portion of the main hub member in which the groove is generally helical about the main axis of the main hub member. Each follower may take the form of a protrusion at an inner end of the propeller blade which extends radially inward relative to the main axis at a position which is radially offset relative to the respective radial axis so as to be arranged for engagement at an inner end within the groove of the respective guide surface.

Some exemplary embodiments of the invention will now be described in conjunction with the accompanying drawings in which:

### BRIEF DESCRIPTION OF THE DRAWINGS

FIG. 1 is a perspective view of the propeller assembly according to a first embodiment;

FIG. 2 is a side elevational view of the propeller assembly according to the first embodiment of FIG. 1;

FIG. 3 is a rear elevational view of the outer side of the propeller assembly according to the first embodiment of FIG. 1;

FIG. 4 is a front perspective view of the inner side of the propeller assembly according to the first embodiment of FIG. 1;

FIG. 5 is a perspective view of an inner side of the propeller assembly with the main hub member shown removed according to the first embodiment of FIG. 1;

FIG. 6 is a perspective view of an outer side of the main hub member shown separated from the propeller assembly according to the first embodiment of FIG. 1;

FIG. 7 is a side elevational view of the main hub member according to the first embodiment of FIG. 1;

FIG. 8 is a perspective view of an inner side of the propeller hub member shown separated from the propeller assembly according to the first embodiment of FIG. 1;

FIG. 9 is a perspective view of one of the propeller blades according to the first embodiment of FIG. 1;

FIG. 10 is a perspective view of two propeller blades connected to the main hub member by the pitch linkage mechanism according to the first embodiment of FIG. 1;

FIG. 11 is a cross sectional view of the propeller assembly along a main axis of the main hub member according to the first embodiment of FIG. 1;

FIG. 12 is perspective view of the propeller assembly according to a second embodiment;

FIG. 13 is an outer end elevational view of the propeller assembly according to the second embodiment of FIG. 12;

FIG. 14 is a perspective view of the assembly according to the second embodiment of FIG. 12 with the propeller hub shown removed;

FIG. 15 is a sectional view of the assembly according to the second embodiment of FIG. 12 along a plane occupied by the main axis of the main hub and the radial axis of one of the propeller blades;

FIG. 16 is a perspective view of the sectioned propeller assembly according to FIG. 15;

FIG. 17 is a perspective view of an inner end of one of the propeller blades shown separated from a respective one of the sockets of the pitch linkage mechanism;

FIG. 18 is a sectional view along the line 18-18 of FIG. 13 of one of the propeller blades in an intermediate angular orientation between the opposing first and second angular orientations corresponding to an intermediate position of the propeller hub relative to the main hub which is in between the first and second positions of the propeller hub; and

FIG. 19 is a sectional view along the line 18-18 of FIG. 13 of one of the propeller blades in the second angular orientation corresponding to the second position of the propeller hub relative to the main hub.

In the drawings like characters of reference indicate corresponding parts in the different figures.

### DETAILED DESCRIPTION

Referring to the accompanying figures, there is illustrated a variable pitch propeller assembly generally indicated by reference numeral 10. The assembly 10 is particularly suited for aircraft, for example light weight or ultralight aircraft. The assembly 10 provides passive blade pitch control without any complex electrical or hydraulic components while remaining fully automated such that no pilot intervention is required.

Although two embodiments are shown in the accompanying figures, the common features of the embodiments will first be described.

The assembly 10 includes a main hub member 12 arranged to be mounted in fixed relation to an outwardly facing motor output of the aircraft. Accordingly, the main hub member 12 is arranged to be rotated about the main axis together with the motor output in a first, forward direction of the motor.

The main hub member 12 includes a base plate portion 14 which is generally circular in shape having an inner mounting face which is arranged for fixed abutment against the motor output on the aircraft. The main hub member further includes a generally cylindrical hollow inner hub portion 16 which is integral with the base plate 14 to project outward from a central location on the base plate. The inner hub portion is fixed to the base plate to forms a singular unitary body such that the inner hub portion rotates together with the base plate about the main axis.

The assembly 10 further includes a propeller hub member 18 having a generally annular main body portion arranged to be supported about the inner hub portion 16 of the main hub member so as to be pivotal relative to one another about the main axis between a first position and a second position as described in further detail below.

The propeller hub member includes a main bore 20 extending axially fully through the propeller hub member from an inner end 22 arranged for abutment against the main hub member and opposing outer end 24 which is spaced outwardly relative to the outer end of the main hub member.

The propeller hub member further includes three propeller mounts 26 at evenly circumferentially spaced positions about the main bore 20 in which each mount 26 comprises a collar portion 28 integral with the main body of the propeller hub member to define a radial bore extending therethrough about a respective radial axis that is radially oriented relative to the main axis of rotation of the propeller assembly. Each mount 26 mounts a respective propeller blade 30 therein such that the propeller blade is pivotal within the collar about the respective radial axis between a first pitch orientation and an opposing second pitch orientation with an infinite number of intermediate pitch orientations defined therebetween.

The propeller assembly 10 further includes a cover member 32 which is mounted against the outer end of the propeller hub member 18 by being fastened in fixed relation to the main hub member 12. Accordingly, the cover member and main hub member are always rotatable together about the main axis of the propeller assembly in fixed relation with one another. The propeller hub member 18 is constrained in the direction of the main axis between the main hub member 12 and the cover member 32.

A first annular bearing 34 is mounted concentrically about the main axis in axial abutment between the main hub member 12 and an inner side of the propeller hub member, while a second annular bearing 36 is similarly concentrically mounted with the main axis for axial abutment between the outer end of the propeller hub member 18 and the cover member 32. The annular bearings also assist in locating the various members relative to one another in the radial direction relative to the main axis as described in further detail below.

In general, the propeller blades 30 maintain their position in the circumferential direction within the respective mounting collars 28 to be pivotal together with the propeller hub member 18 about the main axis relative to the cover member 32 and main hub member 12, between the first and second positions of the propeller hub member.

The outer end of the propeller hub member 18 further comprises an annular groove which receives an annular sealing member such as an O-ring therein in which the sealing member is in sealing rotatable engagement with a corresponding one of the main hub member or the cover member adjacent the outer periphery thereon.

The inner end of the propeller hub member 18 includes a first counter bore 38 which is coaxial with the main bore 20 and main axis of the assembly. The first counter bore 38 has an enlarged diameter relative to the main bore so as to be suitably sized to receive the first annular bearing 34 therein by having a similar outer diameter.

A second counter bore 62 is located at the outer end of the propeller hub member which is larger in diameter than the main bore, but similar in diameter to the first counter bore for receiving the second annular bearing therein similar to the first annular bearing within the first counter bore.

A pitch linkage mechanism is operatively connected between each propeller blade and the main hub member such that each propeller blade is pivotal from the respective first pitch orientation to the respective second pitch orientation together with movement of the propeller hub member relative to the main hub member from the first position to the second position responsive to air resistance in the second direction exceeding a biasing force of the biasing mechanism acting in the forward direction.

In operation, the biasing mechanism initially biases the propeller hub member into the first position corresponding to the first pitch orientation of the blades which is a finer pitch than the second orientation. This orientation is suitable for initial takeoff of the aircraft where more climbing performance is desired. As air speed changes and the aircraft approaches a cruising speed, the air resistance acting against the forward rotation of the propellers about the main axis causes a force of resistance to gradually exceed the initial biasing force of the biasing mechanism retaining the propeller hub member in the first position relative to the main hub member such that the propeller hub member begins to shift towards the second position relative to the main hub member. As the propeller hub member is shifted towards its second position towards an equilibrium position between the air resistance and the biasing force, the propeller blades are accordingly pivoted from the first pitch orientation to the second pitch orientation proportionally with the circumferential shifting of the propeller hub member relative to the main hub member. The pitch of the blades is accordingly adjusted towards a courser pitch which is more efficient as air speed increases.

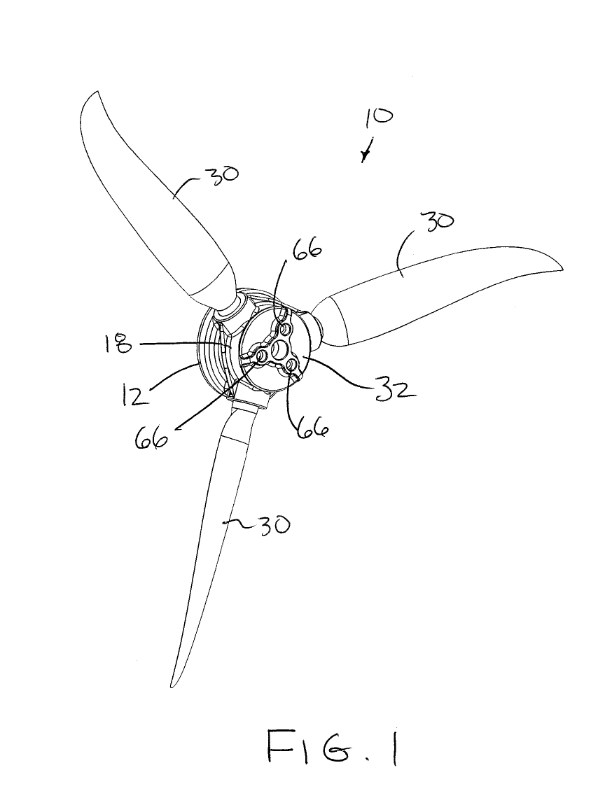

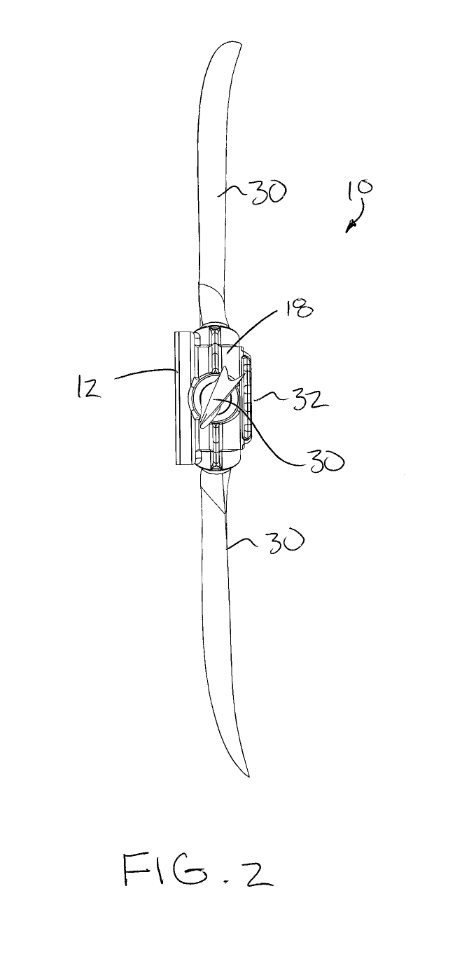

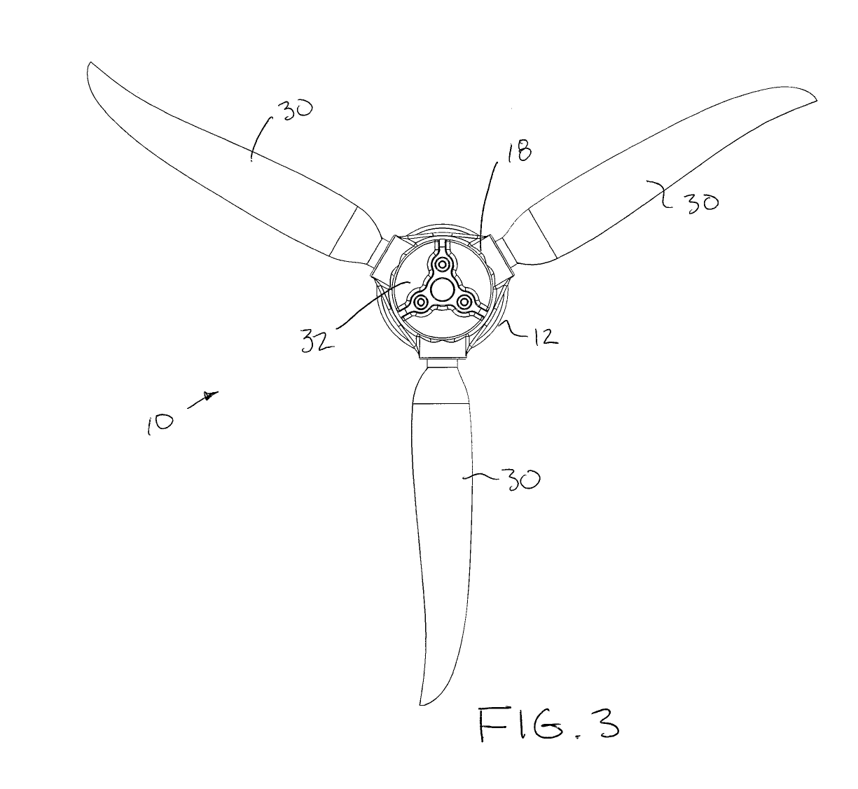

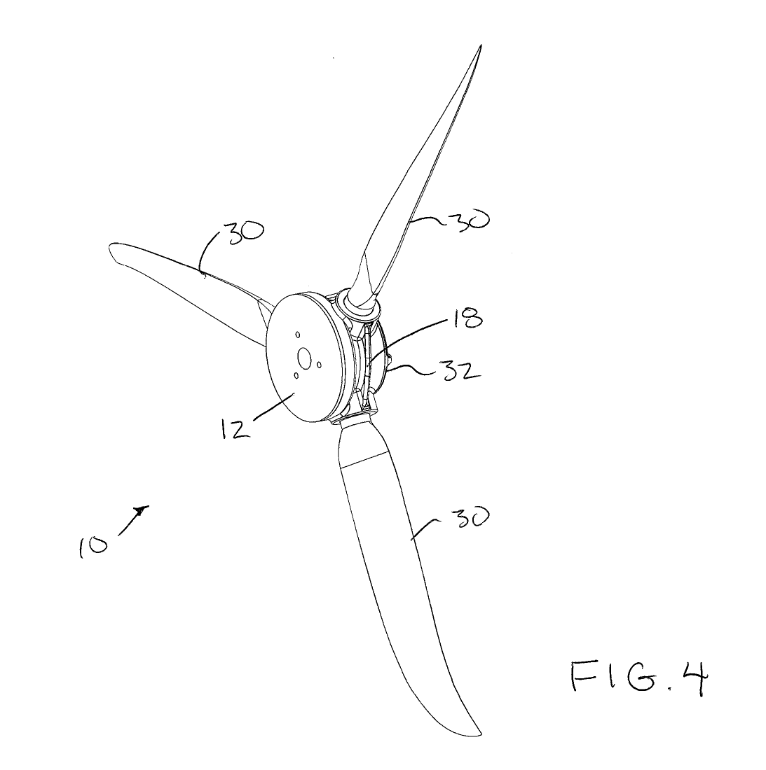

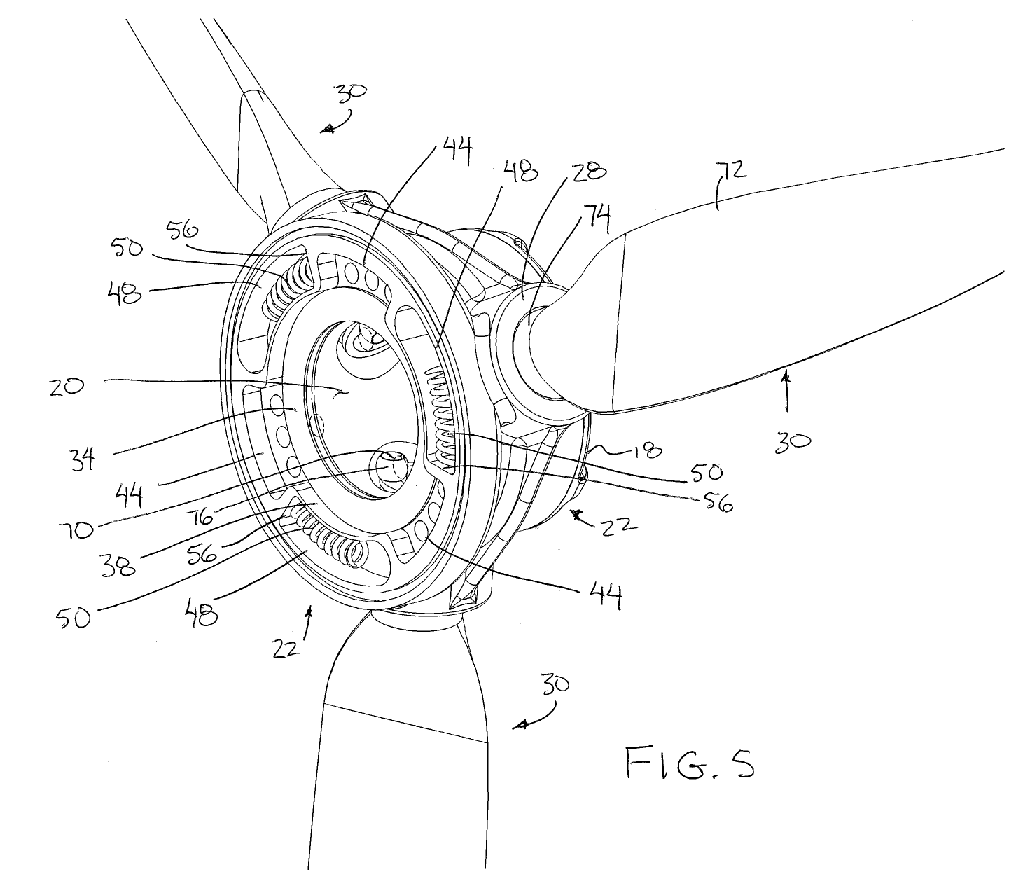

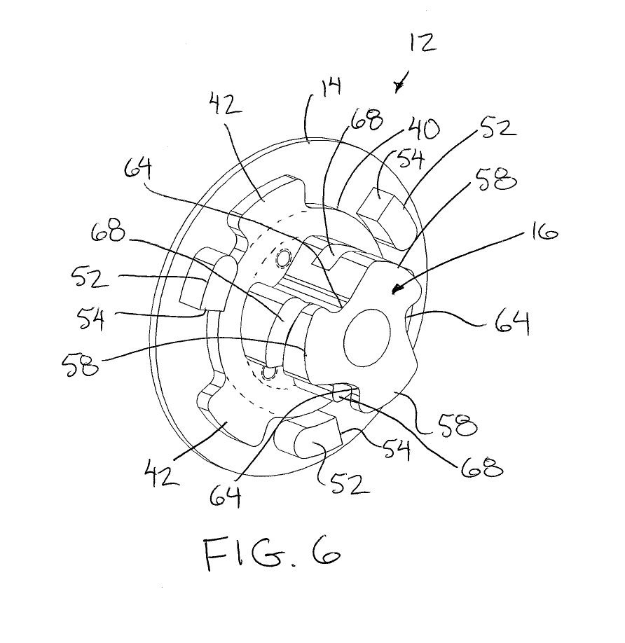

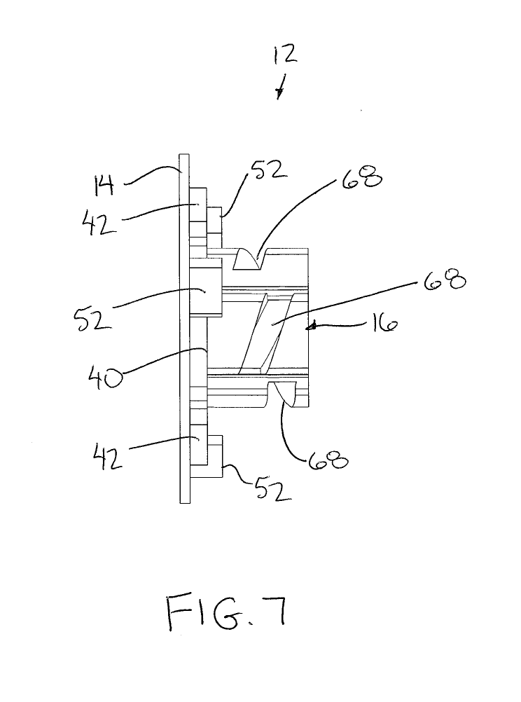

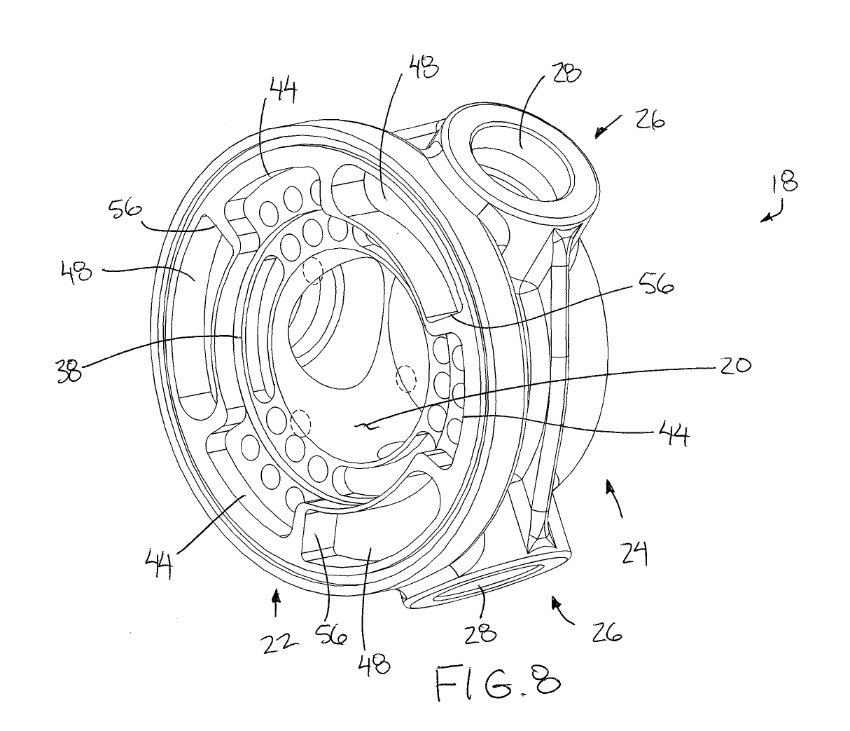

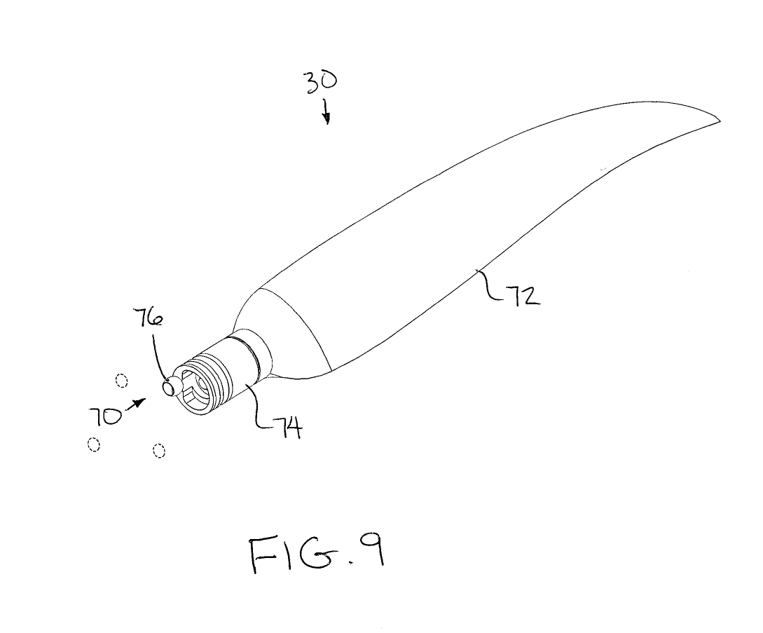

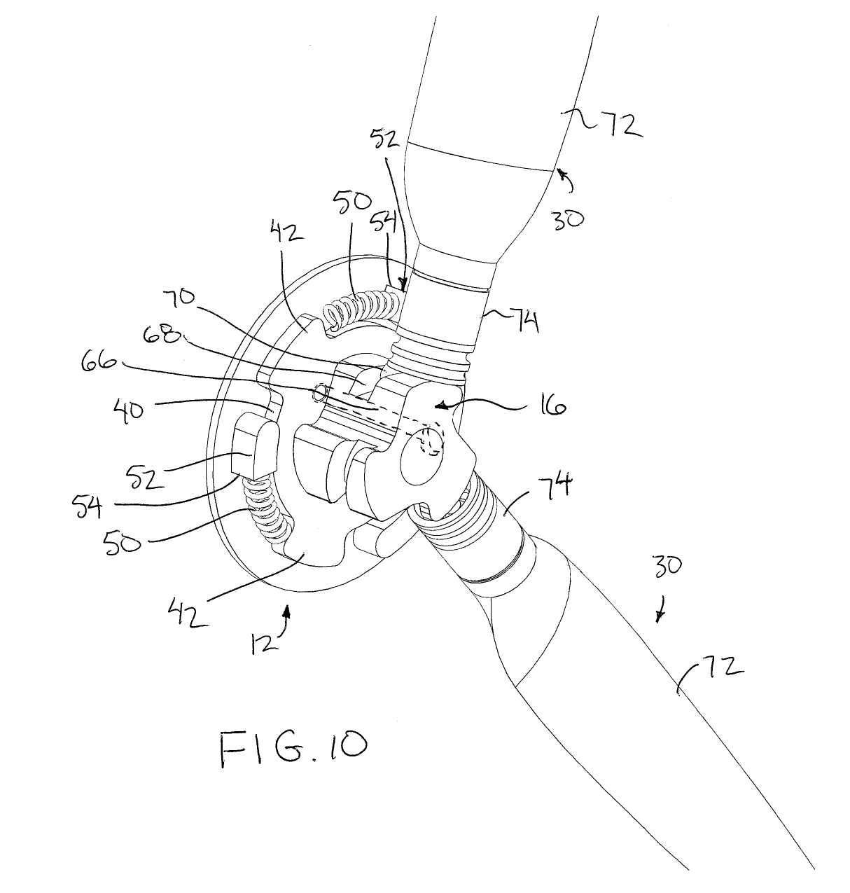

Turning now to the first illustrated embodiment in FIGS. 1 to 11, the propeller assembly 10 is shown arranged in a pusher configuration. In this instance, the propeller assembly is mounted at a rear or trailing position relative to the aircraft. The aircraft typically has a motor output, which in the instance of a pusher configuration is generally rear facing relative to the aircraft. The motor is rotated about a main output axis in a forward direction to provide forward thrust to the aircraft through the propeller assembly 10.

In this instance, the inner hub portion is seamlessly and integrally formed together with the base plate as a singular unitary body such that the inner hub portion is fixed together with the base plate to rotate together about the main axis.

The first counter bore 38 at the inner end of the propeller hub member also receives a raised protrusion 40 at the outer side of the base plate 14 of the main hub member 12 which is generally circular in shape and has an outer diameter that is closely received within the diameter of the first counter bore 38. The axial thickness of the raised protrusion 40 and the first annular bearing 34 together corresponds approximately to the axial dimension of the first counter bore 38 which receives those two components therein.

The raised protrusion 40 at the outer side of the base plate 14 of the main hub member further includes three lobes 42 where a portion of the raised protrusion is increased in radial dimension relative to the main axis while having a constant thickness in the axial direction relative to the raised protrusion. The three lobes 42 are evenly spaced apart in the circumferential direction about the main axis. The lobes are arranged to be received within three corresponding recesses 44 formed at the inner side of the propeller hub member 18. The three recesses correspond to three circumferential spaced areas of the first counter bore 38 where the radial dimension of the counter bore is increased while maintaining a consistent axial depth to be suitable for receiving the three lobes within the three recesses respectively.

The lobes are shorter in length in the circumferential direction than the three recesses such that as the propeller hub member is displaced from the first position to the second position relative to the main hub member corresponding to the propeller hub being circumferentially offset about the main axis in the second position relative to the first position, each lobe 42 is slidably displaced within the respective recess 34 between two opposed ends of the recess in the circumferential direction. The lobes within the respective recesses thus define the limits of relative rotation of the propeller hub member relative to the main hub member in two opposing directions about the main axis.

The propeller hub member 18 also includes three chambers 48 recessed inwardly into the main body at the inner side of the propeller hub member. Each of the three chambers extends in a generally circumferential direction between two terminal ends. The three chambers 48 have a uniform depth in the axial direction. Furthermore, the three chambers 48 are evenly spaced apart from one another in the circumferential direction with each chamber being evenly spaced between a corresponding adjacent pair of the recesses 44 that receive the lobes 42 therein.

Each chamber 48 serves to receive a respective spring 50 of a biasing mechanism therein. The springs interact between the propeller hub member 18 and respective ones of three lugs 52 formed at the outer side of the base plate 14 of the main hub member at positions which are radially outward from the inner hub portion 16 and the circular raised protrusion 40. More particularly, each lug 52 is arranged to be received within a respective one of the three chambers 48 such that the lug is positioned at one of the two circumferentially opposed ends in the first position of the propeller hub member relative to the main hub member. Each lug 52 defines a first abutting surface 54 for abutment against one end of the respective spring 50 which the other end of the spring abuts the opposing terminal end of the respective chamber 48 within which it is received such that the opposing terminal end defines a second abutting surface 56.

Each spring is generally helical about a respective spring axis and is received within the respective chamber such that the spring axis extends generally in the circumferential direction of the propeller assembly between the first and second abutting surfaces at opposing ends thereof. The springs are arranged to be compressed in the circumferential direction between the abutting surfaces, such that the lug 52 remains biased towards one end of the chamber 48. The lugs and springs are oriented such that as the propeller hub member is shifted circumferentially from the first position towards the second position, the lugs 52 are displaced circumferentially within the respective chamber towards the opposing end of the chamber which brings the first and second abutting surfaces towards one another to further compress the respective spring 50 to maintain biasing of the propeller hub member from the second position towards the first position throughout the full range of movement thereof according to a biasing force described by the springs.

The inner hub portion 16 of the main hub member includes three lobes 58 which are circumferentially spaced apart from one another and which span axially between inner and outer ends of the main hub member. The radially outer surfaces of the three lobes define respective portions of a cylindrical surface of prescribed diameter corresponding approximately to the diameter of the main bore 20 of the propeller hub member so as to be received therein in the assembled configuration of the propeller assembly. Each of the three lobes 58 is arranged to be generally aligned with a respective one of the three propeller mounts 26 in the propeller hub member received about the inner hub portion 16.

The cover member 32 has a circular raised portion 60 at the inner side thereof which has a diameter which is approximately equal to the diameter of the main bore 20 of the propeller hub member such that the raised portion 60 is arranged to be received in the main bore at the outer end of the propeller hub member.

The inner diameter of both annular bearings corresponds approximately to the inner diameter of the main bore such that the first annular bearing acts in a radial direction between the first counter bore 38 and the partial cylindrical surface defined by the outer surfaces of the three lobes 58 of the inner hub portion 16 of the main hub member. Similarly, the second annular bearing 36 acts in the radial direction between the counter bore 62 at the outer end of the propeller hub member and the circular raised portion 60 at the inner side of the cover member 32.

The three recessed areas 64 located between adjacent ones of the three lobes 58 of the inner hub portion 16 of the main hub member define respective voids through which three fasteners 66 can be received to extend axially between respective fastener apertures at circumferentially spaced positions in the cover member and respective threaded bores at circumferentially spaced positions in the main hub member to threadably connect the cover member to the main hub member.

Pivotal movement of each propeller blade within the respective propeller blade mount in the propeller hub member is controlled by a pitch linkage mechanism generally comprised of three guide surfaces 68 on the inner hub portion of the main hub member and three followers 70 on respective ones of the three blades. More particularly, each blade is pivotal about a respective radial axis which extends radially outward relative to the main axis to be displaced between a respective first pitch orientation and a second pitch orientation which is courser than the first pitch orientation. The pitch linkage mechanism is operatively connected between each propeller blade and the main hub member such that each propeller blade is pivotal from the respective first pitch orientation to the respective second pitch orientation together with movement of the propeller hub member relative to the main hub member from the first position to the second position responsive to air resistance in a second direction of rotation counter to the forward rotation direction of the propeller assembly when the air resistance exceeds a biasing force of the biasing mechanism.

Each guide surface 68 takes the form of a groove formed in the outer surface of a respective one of the three lobes 58 in which the groove follows a generally helical path about the main axis. The groove serves to contain the respective follower therein to be displaced along the groove as the propeller hub member is shifted circumferentially relative to the main hub member.

Each propeller blade comprises an outer blade portion 72 projecting outwardly from the propeller hub member to define the airfoil section of the blade which provides thrust. Each blade further includes a bearing portion 74 at the inner end of the blade which is received within the respective collar 28 and which permits bearings to be mounted between the bearing portion 74 and the surrounding collar to adequately support the blade for pivotal movement about its respective radial axis. The follower comprises a protrusion which projects radially inwardly towards the main axis of the assembly at a position which is offset radially outward relative to the radial axis of the respective blade.

The protrusion may include a bearing surface or bearing 76 thereon for rotation about a respective axis oriented parallel to the radial axis of the blade so as to be suitable for rolling contact along the respective groove of the respective one of the guide surfaces 68 receiving the follower therein. The angular position of the protrusion relative to the blade is such that shifting of the propeller hub member relative to the main hub member causes the rotation of the follower along the groove to change, which in turn changes the axial position of the follower in the axial direction of the main axis of the assembly to control pivotal orientation of the blade between the first and second pitch orientations thereof.

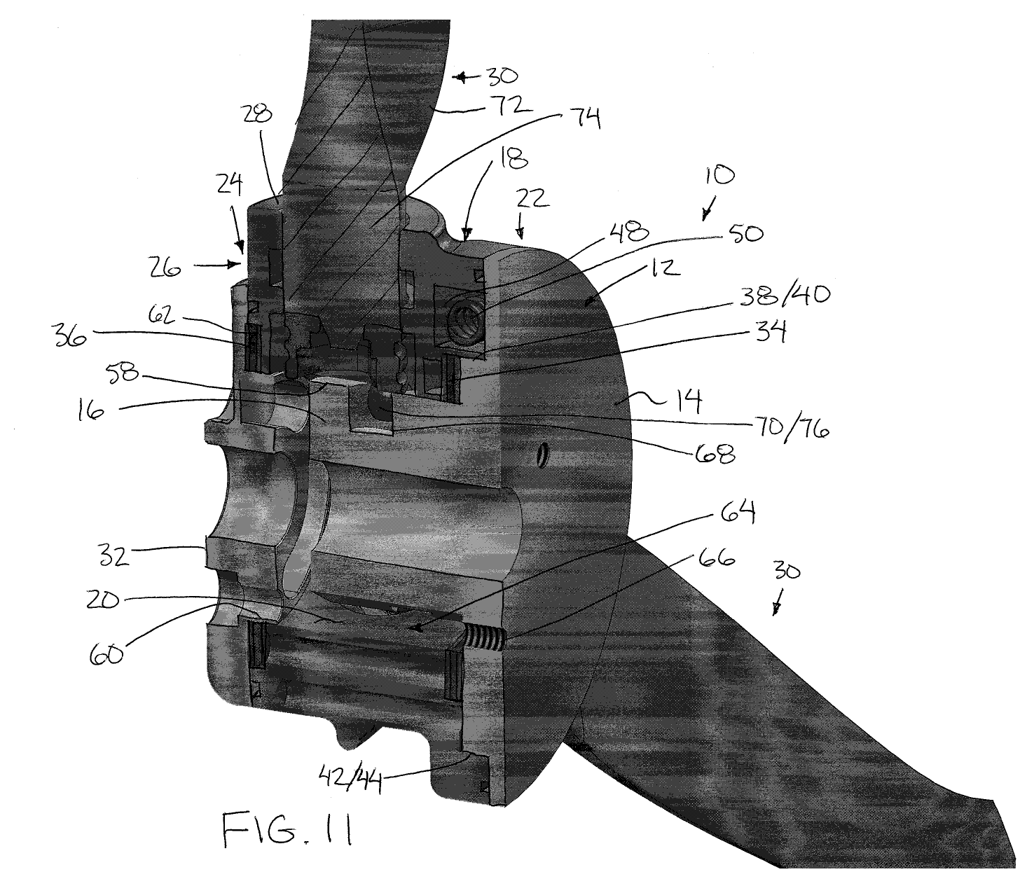

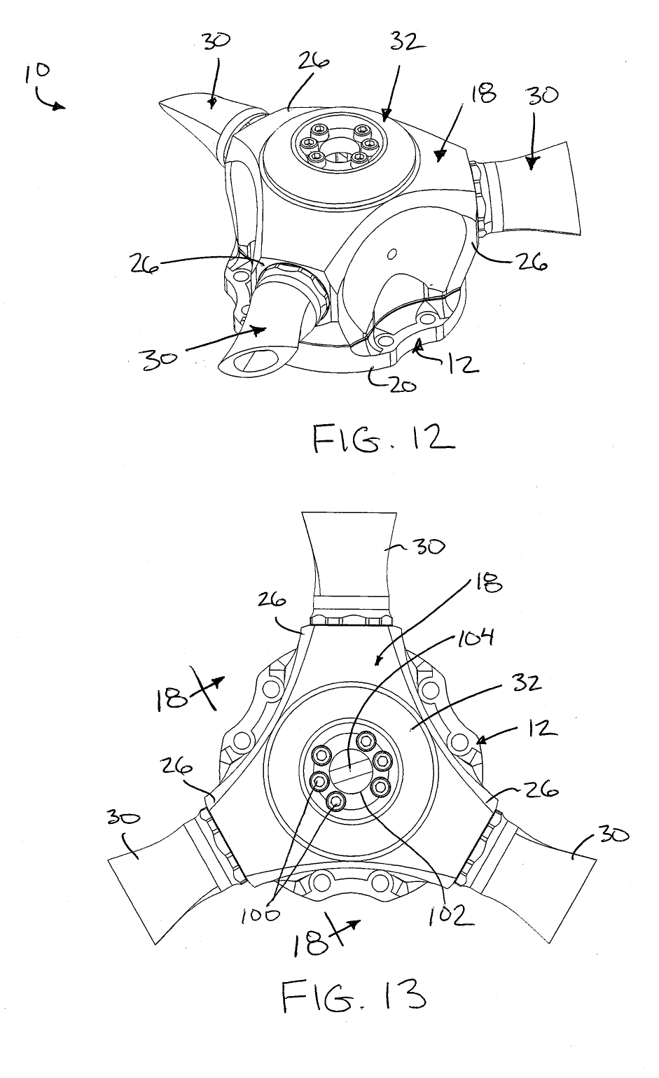

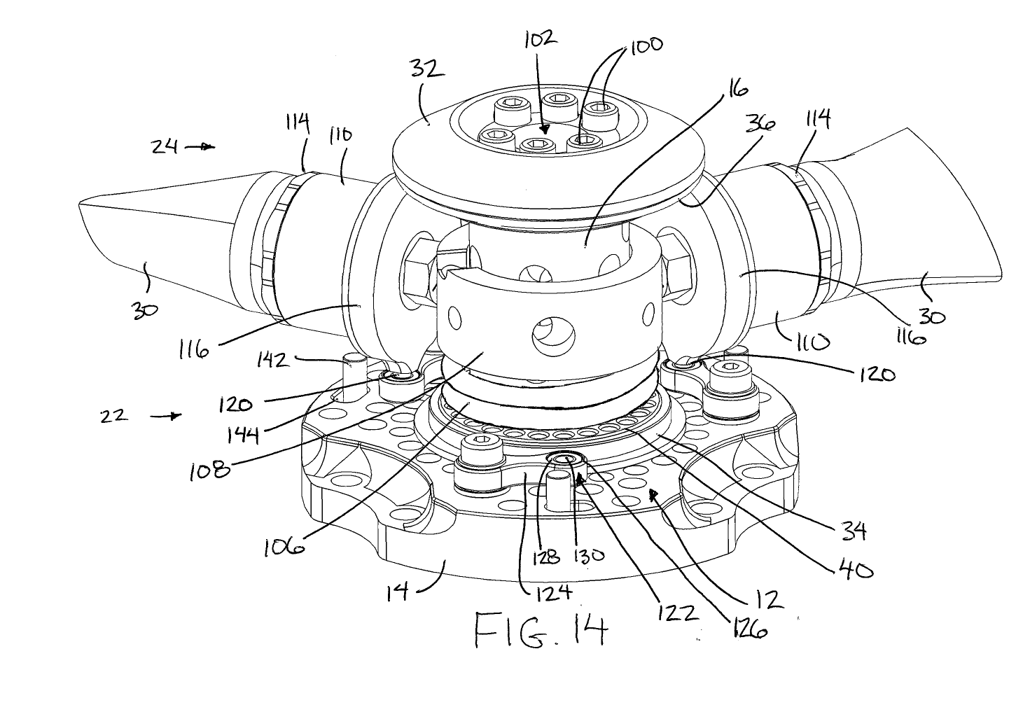

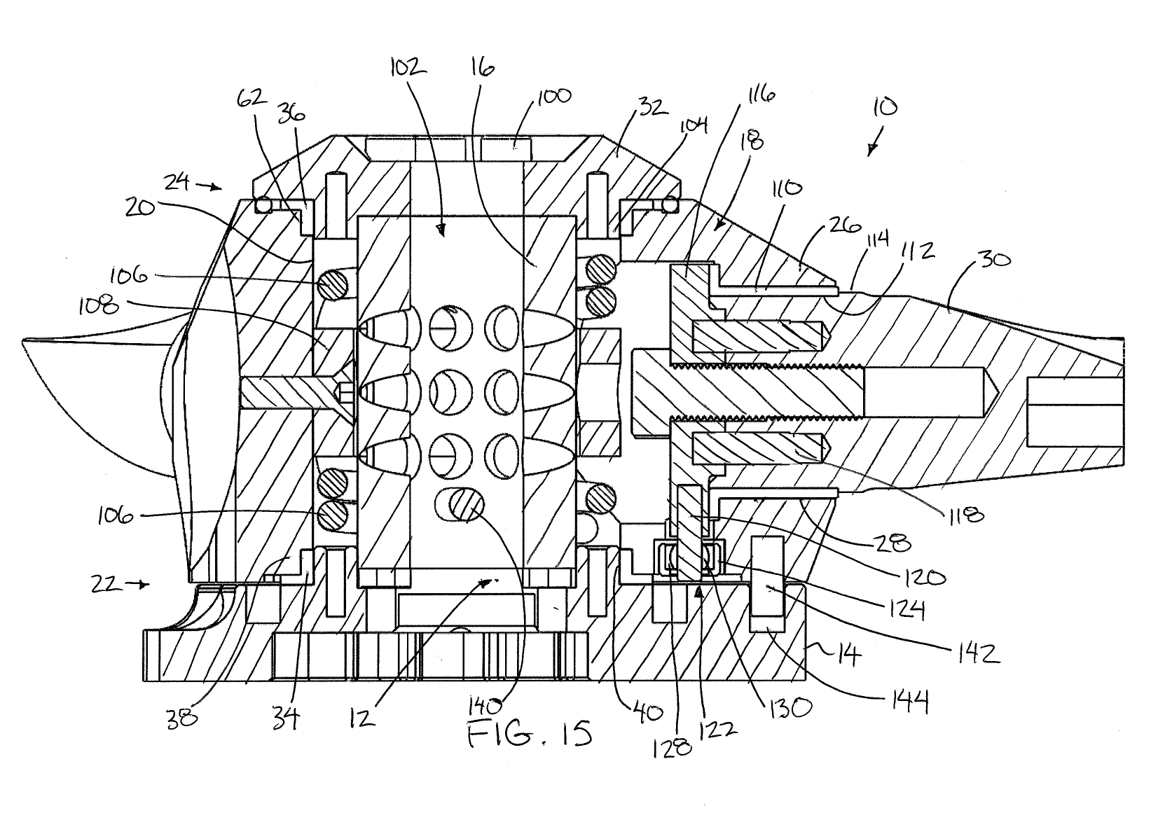

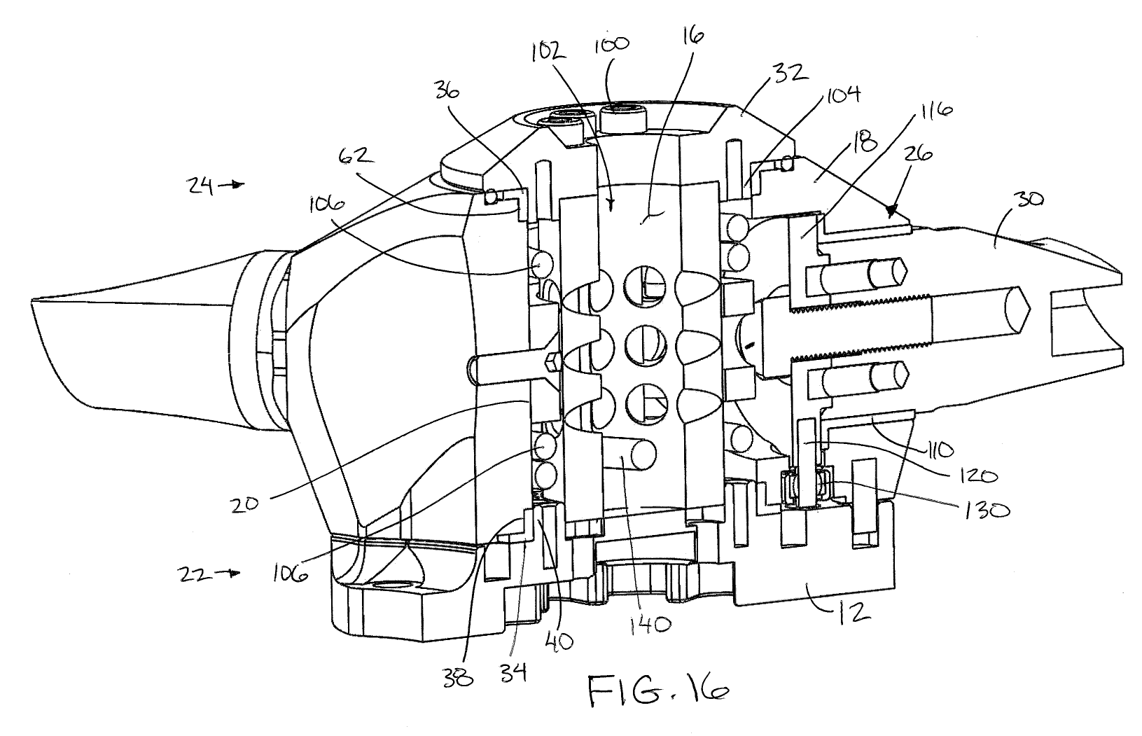

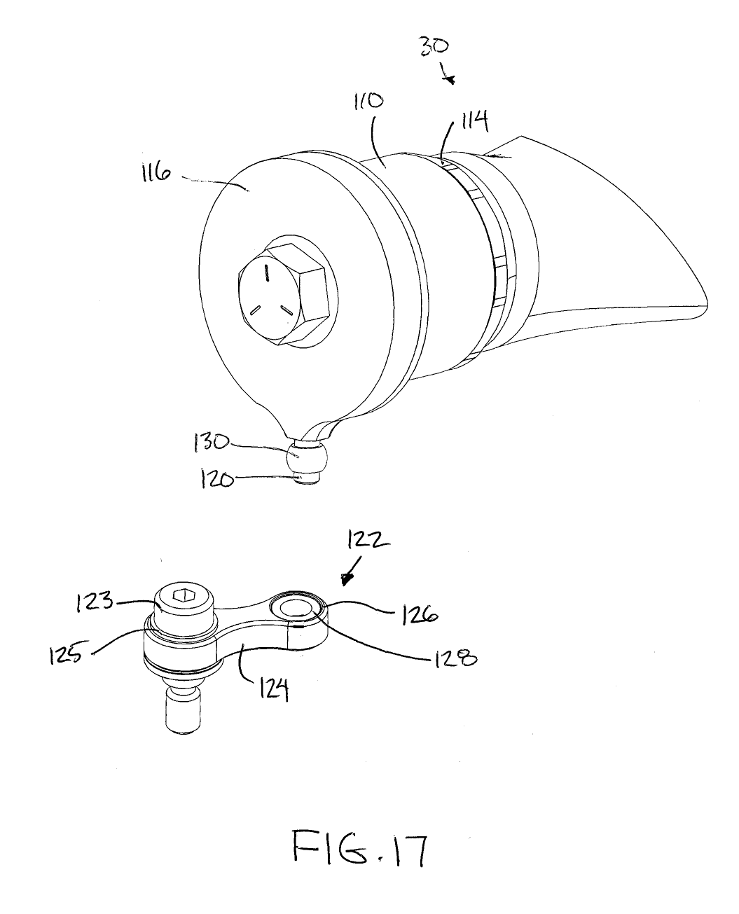

Turning now to the second embodiment shown in FIGS. 12 through 19, the propeller assembly 10 in this instance is again in a pusher configuration and again comprises a propeller hub member 18 which shifts circumferentially between first and second positions to effect a change of blade pitch between first and second pitch orientations through a different configuration of pitch linkage mechanism.

The second embodiment of the propeller assembly includes an inner hub portion 16 formed by a central sleeve having an axial bore therethrough which is fastened at a central location on the base plate portion 14 by axially oriented fasteners 100. More particularly, the sleeve includes axial bores extending therethrough which receive axial fasteners connected between the cover member 32 at the outer end of the sleeve and the base plate portion of the main hub at the inner end thereof. The fasteners 100 are located at circumferentially spaced positions about a central bore 102 extending through the cover member 32 and the sleeve respectively. The fasteners 100 serve to clamp the central sleeve forming the inner hub portion 16 in abutment between the cover member 32 at the outer end thereof and the base plate portion 14 of the main hub at the inner end thereof.

The raised circular protrusion 40 on the base plate portion 14 in this instance locates a central bore therein which locates the inner end of the sleeve forming the inner hub portion 16 therein. The outer surface of the raised circular protrusion 40 is generally cylindrical in shape and is engaged with the bushing defining the first annular bearing 34 which is press-fit into the first counter bore 38 at the inner end 22 of the propeller hub member 18.

The counter bore 62 at the outer end of the main propeller hub 18 includes a bushing forming the second annular bearing 36 press-fit therein as well. An inner cylindrical surface of the second annular bearing 36 receives a raised circular protrusion 104 extending inwardly from the inner face of the cover member 32 fastened at the outer end of the inner hub portion 16 to radially locate the propeller hub member 18 relative to the cover member 32 at the outer end thereof.

A rigid cross member 140 is mounted to span diametrically across the central bore in the inner hub portion 16 aligned with the corresponding bore in the cover member 32. The cross member 140 is in fixed relation to the main hub 12 and serves to form an interlocking connection with a forked post of a starter motor inserted in the axial direction through the outer end of the propeller assembly to provide a starting rotation for starting the motor of the aircraft in a conventional manner.

The propeller hub member 18 includes a set of three stop member protruding 142 axially inward from the inner end face of the propeller hub member. Each stop member 142 is received within a respective one of three slots 144 situated in the outer end face of the base plate portion of the main hub. Each slot 144 extends circumferentially in an arc and has a suitable length between circumferentially opposed terminal ends such that the stop member received therein is displaced between the opposed terminal ends of the slot as the propeller hub member is displaced between the first position and the second position relative to the main hub member.

The biasing mechanism in the second embodiment takes the form of a pair of helical torsion springs 106 which are received at respective inner and outer ends of an annular space between the inner hub portion 16 and the surrounding main bore of the propeller hub member 18. The annular space extends axially the full length of the inner hub portion 16.

A central collar 108 is also located within the annular space at a central location in the axial direction. An outer diameter of the central sleeve closely fits within the inner diameter of the main bore 20 in the propeller hub member. Three radially oriented fasteners are located to be fastened between the central sleeve 108 and the surrounding propeller hub member at circumferentially spaced positions corresponding to intermediate locations between each adjacent pair of blades 30. Clearance is provided between the inner diameter of the central sleeve 108 and the outer diameter of the inner hub portion 16 of the main hub such that there is no interference to the relative pivotal movement therebetween.

One of the helical torsion springs 106 is mounted in the axially extending portion of the annular gap between the central sleeve 108 and the cover member 32 at the outer end of the inner hub portion 16, while the other helical torsion spring is mounted in the axial extending portion of the annular gap between the central sleeve 108 and the base plate portion 14 at the inner end of the inner hub portion 16. The helical torsion springs are each anchored at their outer ends within respective anchoring bores which are radially oriented within the inner hub portion 16 at opposing ends farthest from the central sleeve 108. The springs 106 are anchored within respective axially oriented bores at opposing ends of the central sleeve 108 at the other ends of the helical torsion springs closest to the central sleeves. The helical torsion springs are each wound about a central axis coaxial with the main axis of rotation of the propeller assembly and act together to bias the propeller hub member 18 in the same direction relative to the main hub 12.

In the second embodiment, each blade is rotatably supported within a respective bushing member 110 which is press-fit into the respective collar portion 28 of the propeller hub member. The busing member 110 includes a main collar portion, and a radially extending flange protruding radially outward at the inner of the collar portion. The collar portion and the radial flange portion abut against respective surfaces of the collar portion 28 formed in the propeller hub member.

Each blade 30 includes a cylindrical portion 112 having an outer diameter which is suitably sized for a rotatable fit within the collar portion of the bushing member 110. An integral flange 114 is provided at the outer end of the cylindrical portion to protrude radially outward therefrom to form a shoulder for abutment against the outer end of the bushing member.

A retainer member 116 is fastened at the inner end of the cylindrical portion 112 of each blade having an outer diameter which is greater than the cylindrical portion to define a radial flange at the inner end of each blade which is suitable for abutment against the inner side of the flange portion of the respective bushing member 110. A central bolt aligned with the radial axis of the respective blade retains the retainer member 116 fastened against the inner end of the blade 30 while torque is transferred between each blade and the retainer member 116 by a plurality of pins 118 communicating through respective bores between the retainer member and the body of the blade in the direction of the radial axis of the propeller blade.

The pitch linkage in this instance includes a radial pin 120 and a corresponding socket 122 associated with each propeller member. The radial pin 120 projects radially outward from the retainer member 116 at the inner end of each blade 30. The radial pin 120 rotates together with the blade between the different pitch orientations about the respective longitudinal extending radial axis of the blade.

Each socket 122 is located on the base plate portion 14 of the main hub in association with the respective blade 30. The socket 122 serves to anchor or restrict an outermost end of the respective radial pin 120 in the circumferential direction relative to the main hub 12 as the blades are shifted in the circumferential direction together with the propeller hub member 18 relative to the main hub.

Each socket 122 is provided within a respective anchor body 124 which is fastened to the outermost side of the base plate portion 14 of the main hub using an axially oriented bolt 123. The bolt 123 is coupled to the anchor body 124 by a suitable bushing 125 which allows the anchor body to be pivotal relative to the main hub about an axis which is parallel to the main axis of the propeller assembly. The bolt 123 is situated at a circumferentially spaced location relative to the socket 122 such that the anchor body 124 extends circumferentially from the anchor fastener 123 at one end to a bore 126 at the opposing end. The pivotal mounting of the anchor body 123 at the location of the bolt 123 allows the radial position of the socket 122 relative to the main axis of the propeller assembly to be adjustable as the radial pin is pivoted within a plane which is tangential to the main hub member. The bore 26 in the anchor body 124 locates a collar 128 therein which in turn has a spherical inner surface retaining a spherical bushing 130 rotatable therein. The spherical bushing 130 locates an axial bore therein defining the socket 122 which slidably receives the radial pin 120 of the respective blade therein.

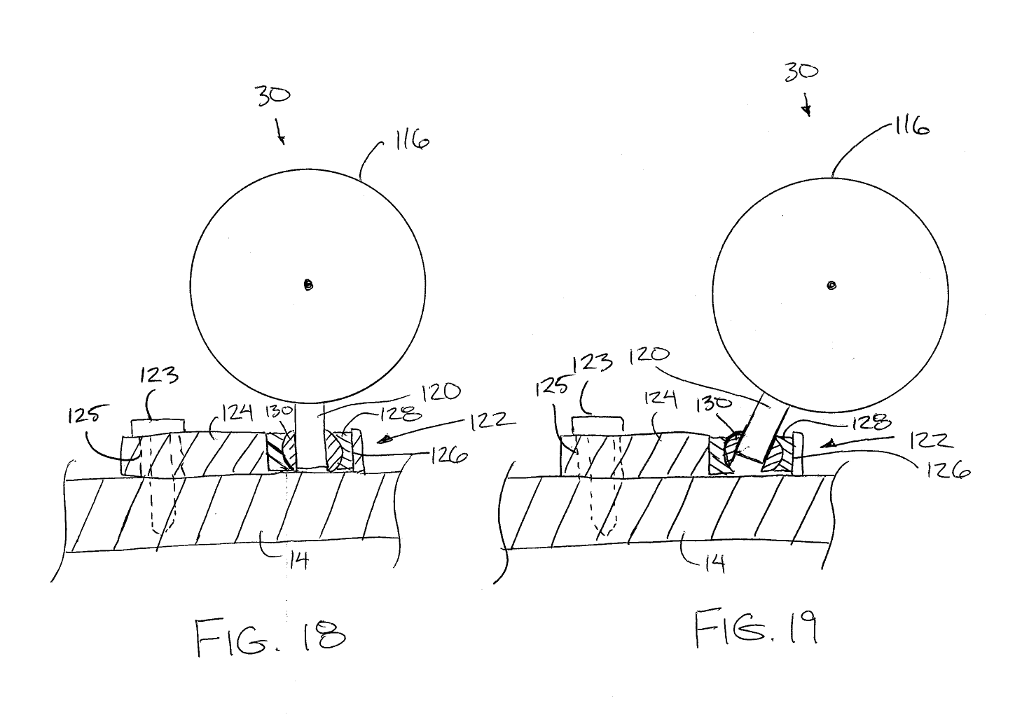

As shown in FIG. 18, in an intermediate position of the propeller assembly which is between the first and second positions thereof, the radial pin 120 of each blade is generally parallel to the axial direction of the main axis of the hub, however, as the propeller hub member 18 shifts circumferentially relative to the main hub to either of the opposing first and second positions, the circumferential position of the spherical bushing 130 defining the socket 122 is displaced relative to the circumferential position of the blade as determined by the collar portion 28 on the propeller hub member which pivotally supports the inner end of the blade therein. The circumferential shifting causes the blades to be shifted between first and second pitch orientations as the propeller hub member is shifted between the first and second positions relative to the main hub. More particularly the angular orientation of each of the radial pins of the three blades is varied together in relation to the angular orientation of the main axis of the hub to change the pitch of the blades responsive to circumferential shifting or pivoting of the propeller hub member 18 relative to the main hub 12 similarly to the previous embodiment. As in the previous embodiment, the first position of the propeller hub member, and the resulting first pitch orientation of the propeller blades, corresponds to an initial course pitch, while the second position of the propeller hub member shown in FIG. 19, and the second pitch orientation of the propeller blades, corresponds to the subsequent finer pitch of the propeller assembly.

Since various modifications can be made in my invention as herein above described, and many apparently widely different embodiments of same made, it is intended that all matter contained in the accompanying specification shall be interpreted as illustrative only and not in a limiting sense.

1. A propeller assembly for use with an aircraft having a motor output driven to rotate by a motor of the aircraft, the propeller assembly comprising:
a main hub member arranged to be coupled in fixed relation to the motor output of the aircraft for rotation therewith about a main axis in a forward direction of rotation;
a propeller hub member supported on the main hub member so as to be movable relative to the main hub member about the main axis in a second direction opposite to the forward direction of rotation between a first position and a second position which is circumferentially offset from the first position;
a biasing mechanism arranged to bias the propeller hub relative to the main hub member from the second position towards the first position;
a plurality of propeller blades supported on the propeller hub member at circumferentially spaced apart positions about the main axis so as to extend generally radially outward from the main axis;
the propeller blades being movable together with the propeller hub member relative to the main hub member between the first position and the second position; and
the propeller blades each being pivotal about a respective radial axis between a respective first pitch orientation and a respective second pitch orientation; and
a pitch linkage mechanism operatively connected between each propeller blade and the main hub member such that each propeller blade is pivotal from the respective first pitch orientation to the respective second pitch orientation together with movement of the propeller hub member relative to the main hub member from the first position to the second position responsive to air resistance in the second direction exceeding a biasing force of the biasing mechanism acting in the forward direction.

2. The propeller assembly according to claim 1 wherein the first pitch orientation of the propeller blades corresponds to a finer blade pitch than the second pitch orientation of the propeller blades.

3. The propeller assembly according to claim 1 further comprising a cover member which is mounted in fixed relation to the main hub member, wherein at least one portion of the propeller hub member is received between the cover member and the main hub member in an axial direction of the main axis.

4. The propeller assembly according to claim 3 further comprising an annular bearing member supported between said at least one portion of the propeller hub member and each one of the main hub member and the cover member.

5. The propeller assembly according to claim 3 wherein the cover member is fixed to the main hub member by at least one fastener extending in a direction of the main axis in fixed connection between the cover member and the main hub member.

6. The propeller assembly according to claim 3 further comprising an annular sealing member in engagement between the propeller hub member and the cover member.

7. The propeller assembly according to claim 3 further comprising at least one stop member protruding axially from one of the main hub member and the propeller hub member, and a slot extending circumferentially in another one of the main hub member and the propeller hub member which receives said at least one stop member therein such that said at least one stop member is displaced between terminally opposed ends of the slop as the propeller hub member is displaced between the first position and the second position relative to the main hub member.

8. The propeller assembly according to claim 1 further comprising a starter bore extending axially through the main hub member from an outer end open to the exterior of the propeller assembly, and a cross member extending diametrically across the starter bore in fixed relation to the main hub member.

9. The propeller assembly according to claim 1 wherein the biasing mechanism comprises at least one helical torsion spring operatively coupled between the main hub member and the propeller hub member.

10. The propeller assembly according to claim 9 wherein said at least one helical torsion spring comprises a pair of helical torsion springs at axially opposing ends of the propeller hub member.

11. The propeller assembly according to claim 9 wherein said at least one helical torsion spring is secured at one end to a collar member which is fixed to the propeller hub member by fasteners.

12. The propeller assembly according to claim 1 wherein the pitch linkage mechanism comprises a pin member fixed to an inner end of each propeller blade to extend radially in relation to the respective radial axis, and a socket at a circumferentially restricted location on the main hub member in association with each propeller blade which receives the respective pin member therein.

13. The propeller assembly according to claim 12 further comprising a spherical bushing which is freely pivotal in each socket, each pin member being received in the respective spherical bushing for relative linear sliding movement therebetween.

14. The propeller assembly according to claim 12 wherein each socket is formed in an anchor body which is supported for pivotal movement relative to the main hub member about a respective axis which is parallel to the main axis.

15. The propeller assembly according to claim 1 wherein the biasing mechanism comprises at least one spring member which is arranged to be compressed in a circumferential direction about the main axis of the main hub member between a first abutting surface on the main hub member and a second abutting surface on the propeller hub member.

16. The propeller assembly according to claim 15 wherein the biasing mechanism comprises a plurality of spring members which are circumferentially spaced apart from one another.

17. The propeller assembly according to claim 1 wherein the pitch linkage mechanism includes a guide surface associated with each propeller blade which is in fixed relation to the main hub member and a follower associated with each propeller blade in mating connection with a respective one of the guide surfaces.

18. The propeller assembly according to claim 17 wherein each guide surface comprises a groove which is generally helical about the main axis of the main hub member.

19. The propeller assembly according to claim 17 wherein each follower comprises a protrusion at an inner end of the propeller blade which extends radially inward relative to the main axis at a position which is radially offset relative to the respective radial axis so as to be arranged for engagement at an inner end with the respective guide surface.
